(19) United States
(12) Patent Application Publication
(10) Pub. No.: US 2009/0087012 A1
(43) Pub. Date: Apr. 2, 2009

(54) SYSTEMS AND METHODS FOR IDENTIFYING SIMILARITIES AMONG ALARMS

(76) Inventors: Matthew Allen Merzbacher, Oakland, CA (US); Todd Gable, Newark, CA (US)

Correspondence Address: General Electric Company;GE Global Patent Operation, PO Box 861, 2 Corporate Drive, Suite 648, Shelton, CT, 06484, US

(21) Appl. No.: 11/863,952

(22) Filed: Sep. 28, 2007

(51) Int. Cl. G06K 9/00; G08B 23/00

(52) U.S. Cl. 382/100; 340/501

(57) ABSTRACT

Systems and methods for classifying targets within a container are provided. In one aspect, a method for resolving an alarm raised by an imaging system is provided, the imaging system alarm triggered by an alarm target including a plurality of objects. The method includes receiving a plurality of images from the imaging system, calculating at least one feature value for each object of the plurality of objects, determining whether each object is part of the alarm target, and rendering a decision on the alarm target.

### FIELD OF THE INVENTION

The systems and methods described herein relate generally to post-detection classification systems and, more particularly, to separating false alarms from true alarms using statistics and probability to identify similar and/or different objects that are grouped together to form a single alarm target.

### BACKGROUND OF THE INVENTION

Since the events of Sep. 11, 2001, the Department of Homeland Security has increased security dramatically in U.S. airports. Such security efforts include screening passengers and carry-on bags and luggage for contraband including explosive materials.

At least some known security scanning systems employ X-ray transmission technology. Although these systems enable the detection of weapons and blades, for example, they lack the capability of detecting explosives with a low false alarm rate.

For example, computed tomography (CT) provides a quantitative measure of material characteristics, regardless of location or the superposition of objects, and a substantial advantage over conventional and multi-view X-ray transmission and radioisotope-based imaging systems. In a CT scanner, a large number of precise X-ray “views” are obtained at multiple angles. These views are then used to reconstruct planar or volumetric images. The image is a mapping of the X-ray mass attenuation value for each volume element (or voxel) within the imaged volume.

Systems employing, for example, CT scanning are used widely in airports around the world on checked luggage to detect explosives that pose a threat to aviation safety. These systems employ an X-ray source and opposing detectors such that a container, e.g., a suitcase, is scanned while translated along a horizontal axis.

At least some known scanning systems are capable of detecting most explosives and other contraband. However, false alarms are occasionally raised due to similarities shared by explosives and other contraband and benign materials. Moreover, although the frequency of false alarms can be reduced by evaluating the material properties of an alarm target, such an evaluation may eliminate from consideration too much of the alarm target which then leads to an incorrect elimination of the entire alarm target. There is a need for a system that can determine if multiple proximate objects are part of the same overall alarm target.

### BRIEF DESCRIPTION OF THE INVENTION

In one aspect, a method for resolving an alarm raised by an imaging system is provided, the imaging system alarm triggered by an alarm target including a plurality of objects. The method includes receiving a plurality of images from the imaging system, calculating at least one feature value for each object of the plurality of objects, determining whether each object is part of the alarm target, and rendering a decision on the alarm target.

In another aspect, a post-detection classification system for use with an imaging system is provided. The imaging system includes a detection component configured to raise an alarm for an alarm target having a plurality of objects. The post-detection classification system is configured to determine whether the plurality of objects are part of the alarm target. The post-detection classification system includes a memory electrically connected to a system bus and at least one processor electrically coupled to the system bus, the at least one processor configured to communicate with the memory. The post-detection classification system is further configured to receive a plurality of images from the imaging system, store the received images in the memory, calculate at least one feature value for each object of the plurality of objects using a plurality of image elements associated with each object, determine whether each object is part of the alarm target, and render a decision on the alarm target.

In another aspect, a method for separating a false alarm from a true alarm is provided, wherein the alarm is triggered by an alarm object. The method includes receiving a plurality of images from an imaging system, the imaging system having raised the alarm, calculating a plurality of feature values for each object of the plurality of objects using a plurality of image elements associated with each object, comparing at least one feature value of the plurality of feature values calculated for a first object of the plurality of objects with the at least one feature value of the plurality of feature values calculated for at least a second object of the plurality of objects, and rendering a decision on the alarm target.

### BRIEF DESCRIPTION OF THE DRAWINGS

FIGS. 1 and 2 show exemplary embodiments of the systems and methods described herein. The embodiments shown in FIGS. 1 and 2 and described by reference to FIGS. 1 and 2 are exemplary only.

FIG. 1 is a block diagram of an exemplary post-detection classification system; and

FIG. 2 shows a flow chart for an exemplary method for processing an alarm using the post-detection classification system shown in FIG. 1.

### DETAILED DESCRIPTION OF THE INVENTION

The embodiments described herein provide systems and methods for processing the output of an imaging system that includes a detection and/or alarm component, and for determining whether multiple pieces classified as an alarm target are actually part of the alarm target. In one embodiment, a post-detection classification system receives images from an imaging system. Using image elements making up the images, the post-detection classification system calculates one or more features for each object that makes up an alarm target. The one or more features are compared for each object to determine whether each object is actually part of the alarm target. Objects determined to not be part of the alarm target are removed and a final decision is rendered for the alarm target.

The systems and methods described herein provide a number of technical effects. One example of a technical effect is reducing the occurrence of false alarms by using a set of calculated features to identify the similarity of objects that have been aggregated together into an alarm target. The algorithm uses image features of the objects to decide if a particular object is actually part of the alarm target or is merely located in close proximity of the alarm target. The algorithm may be tuned to more aggressively or less aggressively eliminate one or more objects from an alarm target, thereby clearing the alarm target as a whole from further investigation.

At least one embodiment of the present invention is described below in reference to its application in connection with and operation of a system for inspecting cargo. However, it should be apparent to those skilled in the art and guided by the teachings herein provided that the invention is likewise applicable to any suitable system for scanning cargo containers including, without limitation, boxes, drums, and luggage, transported by water, land, and/or air, as well as other containers and/or objects.

Moreover, although embodiments of the present invention are described below in reference to its application in connection with and operation of a system incorporating an X-ray computed tomography (CT) scanning system for inspecting cargo, it should apparent to those skilled in the art and guided by the teachings herein provided that any suitable radiation source including, without limitation, neutrons or gamma rays, may be used in alternative embodiments. Further, it should be apparent to those skilled in the art and guided by the teachings herein provided that any scanning system may be used that produces a sufficient number of pixels to enable the functionality of the post-detection classification system described herein.

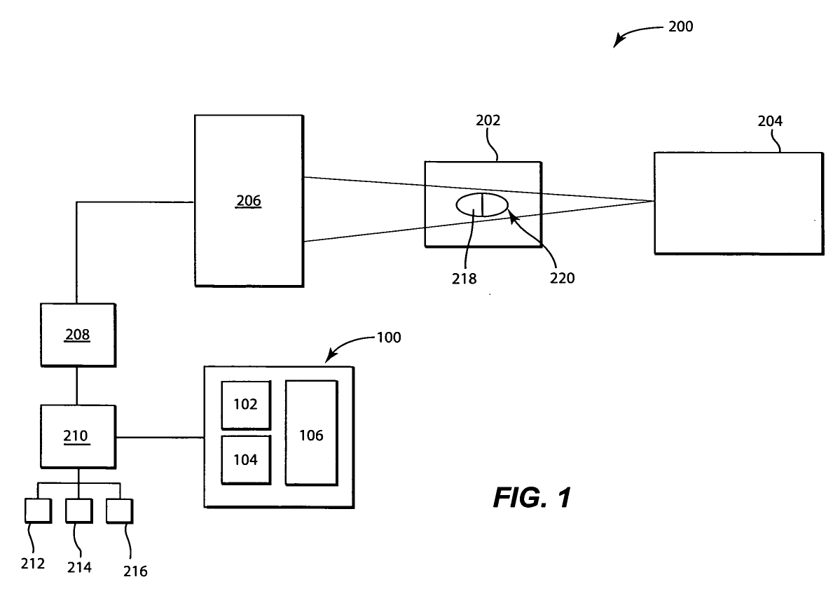

FIG. 1 is a block diagram of an exemplary post-detection classification system 100 used with an X-ray computed tomography (CT) scanning system 200 for scanning a container 202, such as a cargo container, box, or parcel, to identify the contents and/or determine the type of material contained within container 202. The term “contents” as used herein refers to any object and/or material contained within container 202 and may include contraband.

In one embodiment, scanning system 200 includes at least one X-ray source 204 configured to transmit at least one beam of radiation through container 202. In an alternative embodiment, scanning system 200 includes a plurality of X-ray sources 204 configured to emit radiation of different energy distributions. Alternatively, each X-ray source 204 is configured to emit radiation of selective energy distributions, which can be emitted at different times. In a particular embodiment, scanning system 200 utilizes multiple-energy scanning to obtain an attenuation map for container 202. In addition to the production of CT images, multiple-energy scanning enables the production of density maps and atomic number of the object contents. In one embodiment, the dual energy scanning of container 202 includes inspecting container 202 by scanning container 202 at a low energy and then scanning container 202 at a high energy. The data is collected for the low-energy scan and the high-energy scan to reconstruct the CT, density and/or atomic number images of container 202 to facilitate identifying the type of material or contraband within container 202 based on the material content of container 202, as described in greater detail below.

In one embodiment, scanning system 200 also includes at least one X-ray detector 206 configured to detect radiation emitted from X-ray source 204 and transmitted through container 202. X-ray detector 206 is configured to cover an entire field of view or only a portion of the field of view. Upon detection of the transmitted radiation, X-ray detector 206 generates a signal representative of the detected transmitted radiation. The signal is transmitted to a data collection system and/or processor as described below. Upon detection of the transmitted radiation, each X-ray detector element generates a signal representative of the detected transmitted radiation. The signal is transmitted to a data collection system and/or processor as described below. Scanning system 200 is utilized to reconstruct a CT image of container 202 in real time or non-real or delayed time.

In one embodiment of scanning system 200, a data collection system 208 is operatively coupled to and in signal communication with X-ray detector 206. Data collection system 208 is configured to receive the signals generated and transmitted by X-ray detector 206. A processor 210 is operatively coupled to data collection system 208. Processor 210 is configured to produce or generate an image of container 202 and its contents and process the produced image to facilitate determining the material content of container 202. More specifically, in one embodiment data collection system 208 and/or processor 210 produces at least one attenuation map based upon the signals received from X-ray detector 206. Utilizing the attenuation map(s), at least one image of the contents is reconstructed and a CT number, a density and/or an atomic number of the contents is inferred from the reconstructed image(s). Based on these CT images, density and/or atomic maps of the cargo can be produced. The CT images, the density and/or atomic number images are analyzed to infer the presence of contraband, such as, but not limited to, explosives.

In alternative embodiments of scanning system 200, one processor 210 or more than one processor 210 may be used to generate and/or process the container image. One embodiment of scanning system 200 also includes a display device 212, a memory device 214 and/or an input device 216 operatively coupled to data collection system 208 and/or processor 210. As used herein, the term processor is not limited to only integrated circuits referred to in the art as a processor, but broadly refers to a computer, a microcontroller, a microcomputer, a programmable logic controller, an application specific integrated circuit and any other programmable circuit. The processor may also include a storage device and/or an input device, such as a mouse and/or a keyboard.

During operation of an embodiment of scanning system 200, X-ray source 204 emits X-rays in an energy range, which is dependent on a voltage supplied by a power source to X-ray source 204. A primary beam is generated and passes through container 202, and X-ray detector 206, positioned on the opposing side of container 202, measures an intensity of the primary beam.

Alarms raised by scanning system 200 for suspected contraband are then processed by post-detection classification system 100 using a series of image features to identify the similarity of objects 218 that have been grouped together to form alarm target 220. In the exemplary embodiment, the image features include, but are not limited to, statistical features, information theoretical values, and/or textural features. Examples of statistical features include, but are not limited to, mean, median, standard deviation, skew, and/or kurtosis. An example of an information theoretical value is entropy. An example of a textural feature is wavelets. Alternative embodiments of post-detection classification system 100 utilize image features different than and/or in addition to these examples. For example, post-detection classification system 100 calculates the standard deviation of the CT values of the set of voxels that makes up each object 218 that have been grouped together to form alarm target 220. As another example, post-detection classification system 100 calculates the mean of the CT values of the set of voxels that makes up each object 218. In the exemplary embodiment, for alarm target 220 to be cleared as a false alarm, each object 218 belonging to alarm target 220, and having similar image features, must be removed from alarm target 220.

In the exemplary embodiment, post-detection classification system 100 includes one or more processors 102 electrically coupled to a system bus (not shown). System 100 also includes a memory 104 electrically coupled to the system bus such that memory 104 is communicatively coupled to processor 102.

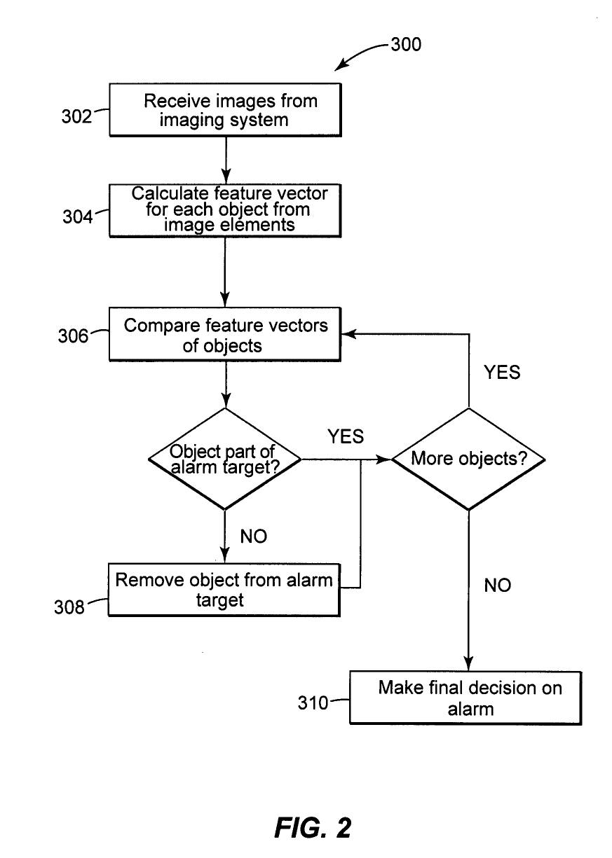

FIG. 2 shows a flow chart illustrating a method 300 for classifying object 218 (shown in FIG. 1) as part of alarm target 220 (shown in FIG. 1) using post-detection classification system 100 (shown in FIG. 1). In the exemplary embodiment, post-detection classification system 100 receives 302 a plurality of images from scanning system 200 (shown in FIG. 1). In one embodiment, system 100 receives 302 the plurality of images automatically when an alarm is triggered in scanning system 200. In an alternative embodiment, a user of scanning system 200 requests a decision on a triggered alarm and system 200 provides system 100 with the plurality of images. For each object 218, system 100 calculates 304 a set of features from a plurality of image elements making up each image, such as pixels or voxels. More specifically, system 100 calculates 304 a set of features, such as the features described above, for each object 218 using the image elements associated with each object 218 currently determined to be part of alarm target 220. In one embodiment, system 100 calculates 304 a mean value of the image elements associated with each object 218. In an alternative embodiment, system 100 calculates 304 a standard deviation value of the image elements associated with each object 218. Alternatively, system 100 may calculate 304 different features of the image elements of each object 218, examples of which are described above.

In the exemplary embodiment, the feature vector of each object 218 of alarm target 220 is compared 306 to the feature vector of the other objects 218 of alarm target 220. The comparison determines whether each object 218 is truly part of alarm target 220 or is a dissimilar object merely positioned near alarm target 220. In one embodiment, each object 218 is considered to be part of alarm target 220 when one or more feature values are within a predetermined range of the same feature values for the other objects 218 of alarm target 220. For example, if a mean value of the image elements of a first object is within 5% of a mean value of the image elements of a second object, the first object is considered part of the alarm target.

In the exemplary embodiment, when a feature value of a first object 218 is sufficiently different from a feature value of a second object 218, first object 218 is removed 308 from alarm target 220. For example, if a mean value of the image elements of a first object is different by at least 10% from a mean value of the image elements of a second object, the first object is removed from the alarm target. The variation allowed between the feature values is adjustable. Accordingly, alternative embodiments will allow for a feature value difference of less than or greater than the given example. If there are more objects 218 to examine within alarm target 220, the steps of comparing 306 feature vectors and removing 308 dissimilar objects from alarm target 220 are repeated until each object 218 has been determined to be part of alarm target 220 or has been removed 308 from alarm target 220. In the exemplary embodiment, system 100 then makes a final decision 310 on alarm target 220. In one embodiment, system 100 clears alarm target 220 from further inspection, e.g., designates alarm target 220 as a false alarm, if all objects 218 are determined to not be part of alarm target 220. Similarly, alarm target 220 is subjected to further inspection, such as a manual inspection, if no objects 218 are removed from alarm target 220. In an alternative embodiment, system 100 clears alarm target 220 from further inspection if a predetermined proportion of objects 218 is determined to not be part of the alarm target 220. Similarly, alarm target 220 is subjected to further inspection if one or more objects 218 are removed but the number of objects 218 removed is too few to clear alarm target 220 as a whole.

In summary, in one embodiment, a method for resolving an alarm raised by an imaging system is provided. The imaging system alarm is triggered by an alarm target including a plurality of objects. The method includes receiving a plurality of images from the imaging system and calculating at least one feature value for each object of the plurality of objects. In an alternative embodiment, calculating a feature value for each object is based on a plurality of image elements associated with each object. In another alternative embodiment, calculating a feature value includes calculating at least one of a mean value of a plurality of image elements associated with each object and a standard deviation value of a plurality of image elements associated with each object.

Moreover, the method also includes determining whether each object is part of the alarm target. In an alternative embodiment, determining whether each object is part of the alarm target includes comparing the feature value of a first object with the feature value of at least a second object. This comparison includes determining whether the feature value of the first object is within a predetermined range of the feature value of the second object.

In addition, the method includes removing an object of the plurality of objects from the alarm target if the object is determined to not be part of the alarm target, and rendering a decision on the alarm target. In an alternative embodiment, rendering a decision on the alarm target includes clearing the alarm target if all objects are determined to not be part of the alarm target.

The above-described systems and methods facilitate inspecting cargo containers efficiently and reliably. More specifically, the systems and methods facilitate effectively processing the output of an imaging system that includes a detection and/or alarm component to detect contraband and to classify alarms as true alarms or as false alarms. Use of image features of objects grouped together into an alarm target facilitates identifying similarities of the objects. Identifying similarities of the objects facilitates preventing over-aggressive or under-aggressive elimination of the entire alarm target as a false alarm. Automatically determining the truth of an alarm facilitates reducing the number of manual inspections that must be completed, thereby reducing the need for inspection personnel and/or reducing time spent by passengers in security lines.

Exemplary embodiments of a system and method for inspecting cargo are described above in detail. The system and method are not limited to the specific embodiments described herein, but rather, components of the system and/or steps of the method may be utilized independently and separately from other components and/or steps described herein. Further, the described system components and/or method steps can also be defined in, or used in combination with, other systems and/or methods, and are not limited to practice with only the system and method as described herein.

While the above-described systems and methods have been described in terms of various specific embodiments, those skilled in the art will recognize that the invention can be practiced with modification within the spirit and scope of the claims.

1. A method for resolving an alarm raised by an imaging system, the alarm triggered by an alarm target including a plurality of objects, said method comprising:
receiving a plurality of images from the imaging system;
calculating at least one feature value for each object of the plurality of objects;
determining whether each object is part of the alarm target; and
rendering a decision on the alarm target.

2. A method in accordance with claim 1, wherein the step of calculating at least one feature value further comprises using a plurality of image elements associated with each object.

3. A method in accordance with claim 1, wherein the step of calculating at least one feature value further comprises calculating at least one of a mean value of a plurality of image elements associated with each object and a standard deviation value of a plurality of image elements associated with each object.

4. A method in accordance with claim 1, wherein the step of determining whether each object is part of the alarm target further comprises:
comparing the at least one feature value of a first object of the plurality of objects with the at least one feature value of at least a second object of the plurality of objects; and
determining whether the at least one feature value of the first object is within a predetermined range of the at least one feature value of the second object.

5. (canceled)

6. A method in accordance with claim 1, further comprising removing an object of the plurality of objects from the alarm target if the object is determined to not be part of the alarm target.

7. A method in accordance with claim 1, wherein the step of rendering a decision further comprises clearing the alarm target if all objects of the plurality of objects are determined to not be part of the alarm target.

8. A post-detection classification system for use with an imaging system comprising a detection component configured to raise an alarm for an alarm target comprising a plurality of objects, said post-detection classification system configured to determine whether the plurality of objects are part of the alarm target, said post-detection classification system comprising:
a memory electrically connected to a system bus; and
at least one processor electrically coupled to said system bus, said at least one processor configured to communicate with said memory, said post-detection classification system further configured to:
receive a plurality of images from the imaging system;
store the received images in said memory;
calculate at least one feature value for each object of the plurality of objects using a plurality of image elements associated with each object;
determine whether each object is part of the alarm target; and
render a decision on the alarm target.

9. A post-detection classification system in accordance with claim 8, wherein said at least one feature value comprises at least one of a mean value of a plurality of image elements associated with each object and a standard deviation value of a plurality of image elements associated with each object.

10. A post-detection classification system in accordance with claim 8, wherein said post-detection classification system is further configured to compare the at least one feature value of a first object of the plurality of objects with the at least one feature value of at least a second object of the plurality of objects.

11. A post-detection classification system in accordance with claim 10, wherein said post-detection classification system is further configured to determine whether the at least one feature value of the first object is within a predetermined range of the at least one feature value of the second object of the plurality of objects.

12. A post-detection classification system in accordance with claim 8, wherein said post-detection classification system is further configured to remove an object of the plurality of objects from the alarm target when the object is not part of the alarm target.

13. A post-detection classification system in accordance with claim 8, wherein said post-detection classification system is further configured to clear the alarm target all objects of the plurality of objects are not part of the alarm target.

14. A post-detection classification system in accordance with claim 8, wherein said post-detection classification system is further configured to clear the alarm target when a predetermined proportion of the plurality of objects is not part of the alarm target.

15. A method for separating a false alarm from a true alarm, the alarm triggered by an alarm object, said method comprising:
receiving a plurality of images from an imaging system, the imaging system having raised the alarm;
calculating a plurality of feature values for each object of the plurality of objects using a plurality of image elements associated with each object;
comparing at least one feature value of the plurality of feature values calculated for a first object of the plurality of objects with the at least one feature value of the plurality of feature values calculated for at least a second object of the plurality of objects; and
rendering a decision on the alarm target.

16. A method in accordance with claim 15, wherein the step of calculating further comprises calculating at least one of a mean value of the plurality of image elements associated with each object and a standard deviation value of the plurality of image elements associated with each object.

17. A method in accordance with claim 15, wherein the step of comparing further comprises determining whether the at least one feature value calculated for the first object is within a predetermined range of the at least one feature value calculated for the at least the second object.

18. A method in accordance with claim 15, further comprising removing an object of the plurality of objects from the alarm target when the object is not part of the alarm target.

19. A method in accordance with claim 15, wherein the step of rendering a decision further comprises clearing the alarm target when all objects of the plurality of objects are not part of the alarm target.

20. A method in accordance with claim 15, wherein the step of rendering a decision further comprises clearing the alarm target when a predetermined proportion of the plurality of objects is not part of the alarm target.

21. A method in accordance with claim 1 wherein the step of rendering a decision further comprises clearing the alarm target when a predetermined proportion of the plurality of objects is not part of the alarm target.
